(19) United States
(12) Patent Application Publication
(10) Pub. No.: US 2008/0180855 A1
(43) Pub. Date: Jul. 31, 2008

(54) Single stopper pin for controlling magnetic head placement in disk drive devices, and methods of making the same

(75) Inventors: Masahiko Fujioka, Hong Kong (CN); Yiu Sing Ho, Hong Kong (CN); Yi Wan, Dongguan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/700,262

(22) Filed: Jan. 31, 2007

(51) Int. Cl. G11B 5/55

(52) U.S. Cl. 360/264.7

(57) ABSTRACT

A voice coil motor for use in a disk drive device suitable for causing rotation of a head gimbal assembly connected to a first end of the voice coil motor is provided. At least one protrusion may protrude from a second end of the voice coil motor, with the second end of the voice coil motor being opposed to the first end. The voice coil motor may be rotatable to move a head connected to the head gimbal assembly for a read and/or write operation and for parking. The protrusion may be disposed on the voice coil motor so as to cooperate with a single pin to define first and second maximum positions beyond which the voice coil motor cannot rotate. In certain example embodiments, the first maximum position may be a load position limit beyond which the voice coil motor cannot rotate during a read/write operation, and the second maximum position may be a park position limit beyond which the voice coil motor cannot rotate when the head is parked.

### FIELD OF THE INVENTION

The example embodiments herein relate to information recording disk drive devices and, more particularly, to disk drive devices having single stopper pins for controlling magnetic head placement and methods of making the same.

### BACKGROUND OF THE INVENTION

One known type of information storage device is a disk drive device that uses magnetic media to store data and a movable read/write head that is positioned over the media to selectively read from or write to the disk.

FIG. 1 is a partial schematic view of a conventional disk drive device. As shown in FIG. 1, the disk drive device includes a magnetic disk 100 as a data storage medium, which is mounted on a spindle motor 102 that rotates the disk 100 at a high speed. The clamp 104 is located on top of the disk 100 to keep it substantially vertically fixed during rotation. A voice coil motor (VCM) 106 (only partially visible because it is located under cover 108) controls the movement of the suspension 112 about the bearing 110 and thus further controls a head (not shown) mounted on a slider, in turn, mounted on the nose portion 114 of the head gimbal assembly (HGA) 116. Thus, the VCM 106 causes the head to move from track-to-track across the surface of the disk 100 to read data from and write data to the disk 100. Finer positioning may be accomplished by means of a micro-actuator (e.g., a dual-stage PZT micro-actuator) as disclosed, for example, in JP 2002-133803; U.S. Pat. Nos. 6,671,131 and 6,700,749; and U.S. Publication No. 2003/0168935, the entire contents of each of which hereby are incorporated herein by reference. A ramp 118 on which the slider parks when it not moving helps to protect the head and the disk 100 from being damaged (e.g., as caused by shocks from external forces, crashes, etc.). Flexible (or flat) power cable (FPC) 120 provides electrical connection (e.g., to the VCM 106). A base 120 supports the structures described above, which are also surrounded by a frame 124.

FIG. 2 is a partial schematic view of the conventional disk drive device of FIG. 1, with many of the elements described with reference to FIG. 1 removed for explanatory purposes. As shown in FIG. 2, two stopper pins 200a-b are provided (e.g., underneath the cover 108). The stopper pins 200a-b respectively correspond to the outer positions of the read/write and unload positions of the head. That is, the VCM should not rotate past the positions defined by the stopper pins 200a-b. As shown in FIG. 2, these two stopper pins 200a-b are extruded from the motor base, for example, by molding, mechanical assembly, or any other suitable means.

As shown in FIG. 3, when current passes through VCM 106, the HGA 116 will be rotated to the loading position with respect to a track of the disk 100 via this controlling signal. If the HGA 116 happens to lose control, the stopper pin 200a will reduce the chances of the head crashing into the clamp 104 by setting a maximum load position (or load position limit). Thus, FIG. 3 shows how the stopper pin 200a of FIG. 2 may help to set a maximum load position or load position limit.

As shown in FIG. 4, when the disk drive device is shut off (or in another non-working condition), there will be no controlling signal (or an incorrect controlling signal) supplied to the VCM 106. Accordingly, the HGA 116 will return to the unloading position by means of a flex bias force, and the head will be parked on the ramp 118. This will, for example, protect the head and/or disk 100 from damage (e.g., from external forces, shocks, etc.) and allow for easy loading of the head the next time the disk drive device is to operated. Thus, FIG. 4 shows how the stopper pin 200b of FIG. 2 may help to set a maximum unloading position or unload position limit.

While these structures traditionally have been suitable for conventional disk drive devices, further refinements still are possible. For example, when the disk drive device is in the process of shutting down (or already shut down), there typically is no controlling signal to control and/or maintain the exact unloading position. Thus, the head and/or the entire HGA 116 may crash into the base 122 and/or the disk 100, causing damage to certain components of the disk drive device. Similarly, it is difficult to control the flexing of the FPC 120, for example, to cause a flex bias force to be applied, the flex bias force being suitable for fixing a certain unloading position for the HGA 116 and for ensuring that the head is parked on ramp. Accordingly, the usefulness of the stopper pin 200b is reduced. Additionally, the requirement of two stopper pins located apart from each other serves to increase the size of the overall disk drive device.

Thus, it will be appreciated that there is a need in the art for improved techniques for controlling the outer limits of magnetic head placement.

### SUMMARY OF THE INVENTION

One aspect of certain example embodiments described herein relates to a single stopper pin being used to set the outer limits of magnetic head placement in a disk drive device.

Another aspect of certain example embodiments described herein relates to a coil overmold extrusion design to cooperate with a single stopper pin to set the outer limits of magnetic head placement in a disk drive device.

Still another aspect of certain example embodiments described herein relates to smaller and/or more compact disk drive devices.

According to certain example embodiments, a voice coil motor for use in a disk drive device suitable for causing rotation of a head gimbal assembly connected to a first end of the voice coil motor is provided. At least one protrusion may protrude from a second end of the voice coil motor, with the second end of the voice coil motor being opposed to the first end. The voice coil motor may be rotatable to move a head connected to the head gimbal assembly for a read and/or write operation and for parking. The protrusion may be disposed on the voice coil motor so as to cooperate with a pin to define first and second maximum positions beyond which the voice coil motor cannot rotate.

According to certain other example embodiments, a disk drive device is provided. The disk drive device may comprise a disk; a spindle motor operable to spin the disk; a pin; and, a voice coil motor suitable for causing rotation of a head gimbal assembly connected to a first end of the voice coil motor, with the voice coil motor including at least one protrusion protruding from a second end of the voice coil motor, and with the second end of the voice coil motor being opposed to the first end. The voice coil motor may be rotatable to move a head connected to the head gimbal assembly for a read and/or write operation and for parking. The protrusion may be disposed on the voice coil motor so as to cooperate with the pin to define first and second maximum positions beyond which the voice coil motor cannot rotate.

According to still other example embodiments, a method of making a voice coil motor for use in a disk drive device suitable for causing rotation of a head gimbal assembly connected to a first end of the voice coil motor is provided. The method may comprising providing at least one protrusion on a second end of the voice coil motor, with the second end of the voice coil motor being opposed to the first end. The protrusion may be disposed on the voice coil motor so as to cooperate with a pin to define first and second maximum positions beyond which the voice coil motor cannot rotate.

In certain example embodiments, the first maximum position may be a load position limit beyond which the voice coil motor cannot rotate during a read/write operation, and the second maximum position may be a park position limit beyond which the voice coil motor cannot rotate when the head is parked.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a partial schematic view of a conventional disk drive device;

FIG. 2 is a partial schematic view of the conventional disk drive device of FIG. 1, with many of the elements described with reference to FIG. 1 removed for explanatory purposes;

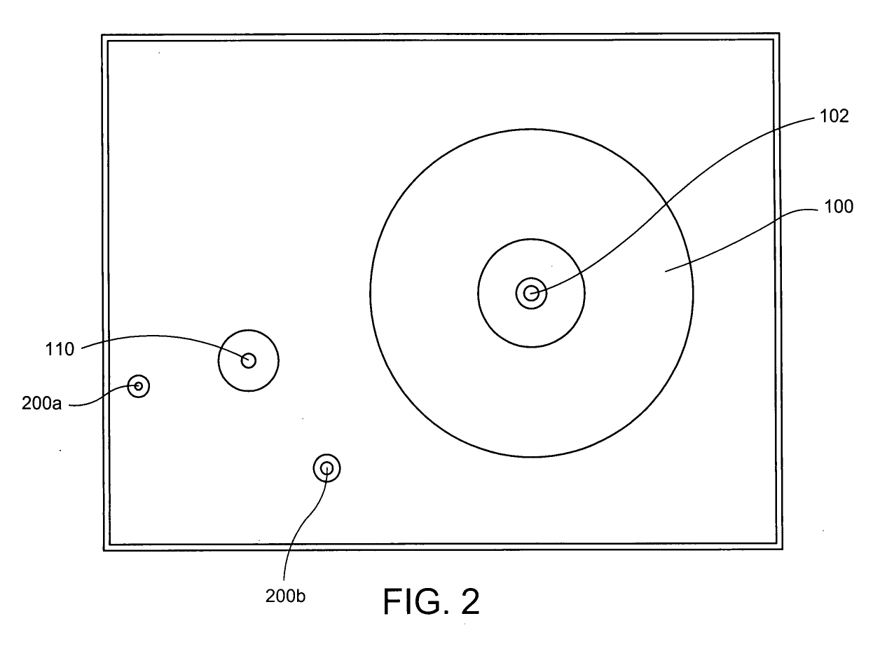

FIG. 3 shows how the stopper pin of FIG. 2 may help to set a maximum load position or load position limit;

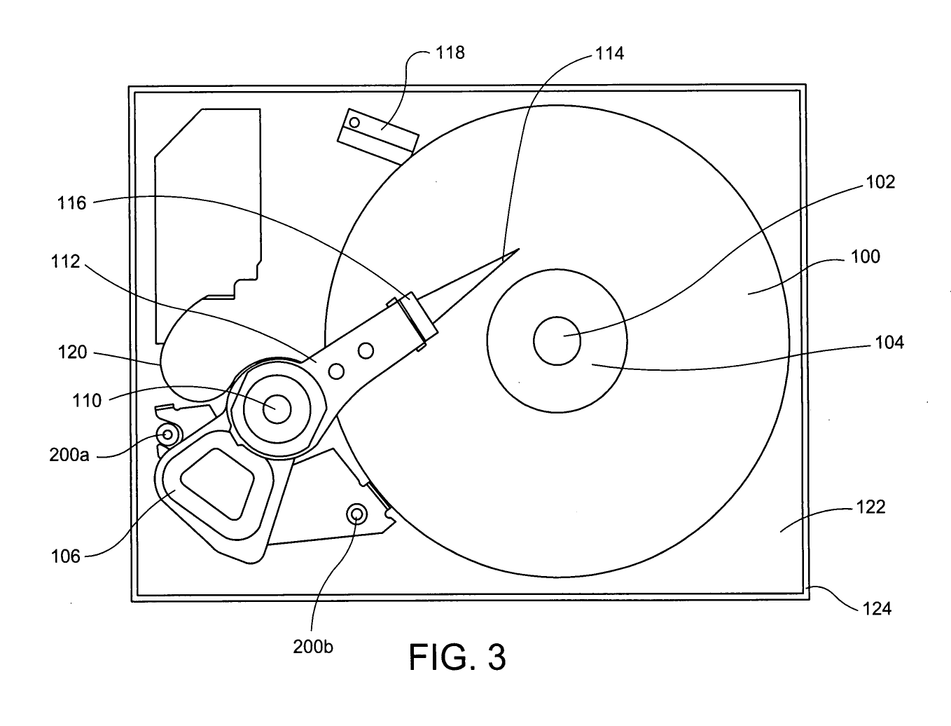

FIG. 4 shows how the stopper pin of FIG. 2 may help to set a maximum unloading position or unload position limit;

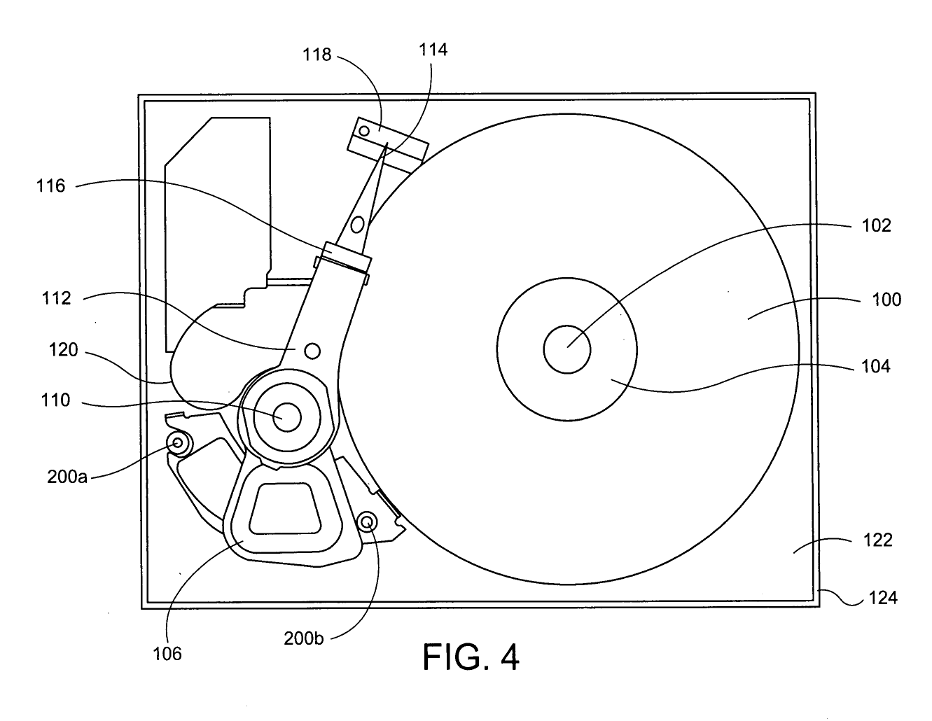

FIG. 5 is a disk drive device having a VCM overmold with an overmold extrusion for cooperating with a single stopper pin, in accordance with an example embodiment;

FIG. 6 is a partial schematic view of a disk drive device having a VCM overmold with an overmold extrusion for cooperating with a single stopper pin with the HGA being in a read/write mode, in accordance with an example embodiment; and,

FIG. 7 is a partial schematic view of a disk drive device having a VCM overmold with an overmold extrusion for cooperating with a single stopper pin with the HGA being in a parked mode, in accordance with an example embodiment.

### DETAILED DESCRIPTION OF ILLUSTRATED EMBODIMENTS

Currently, two separate stopper pins are used to define maximum head read/write and unloading positions. Such pins stop the distal end of the HGA from over-rotation, which could cause damage to one or more elements in the disk drive device (e.g., the head, VCM, disk, etc.). In particular, the VCM typically has an overmold formed thereon, and one stopper pin stops the overmold to reduce the likelihood of the HGA crashing into the clamp of the spindle motor during read/write operations, whereas the other stopper pin holds the overmold when the disk drive device is powered down to keep the HGA away from the disk. As such, according to these conventional techniques, both pins are needed, requiring additional mechanical structures and space for the same.

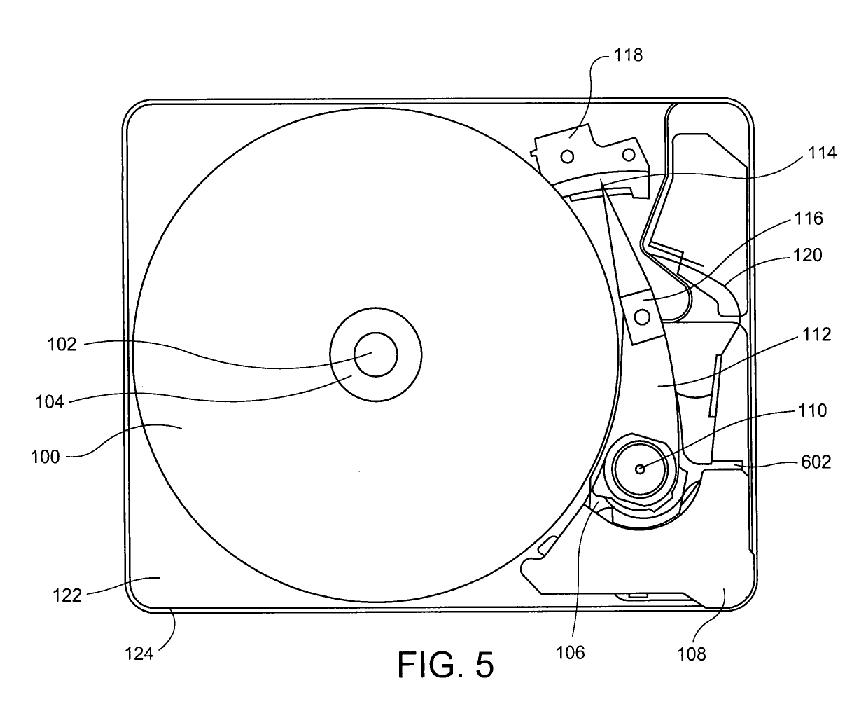

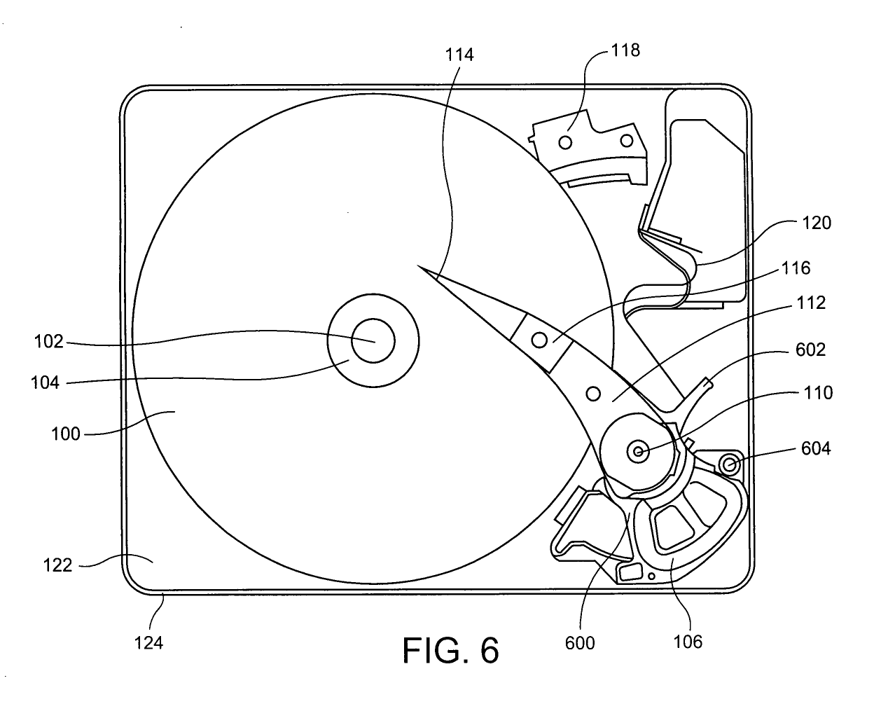

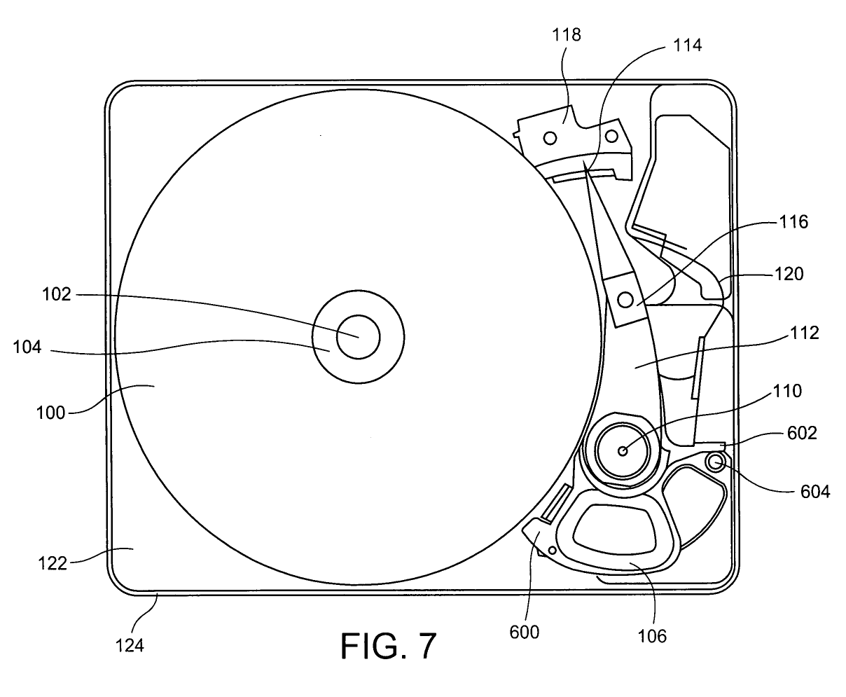

By contrast, certain example embodiments require only a single stopper pin. An extrusion (or protrusion) projects from the overmold, and the extrusion design may cooperate with the single stopper pin. The single stopper pin and overmold extrusion may reduce the likelihood of the HGA crashing into the clamp of the spindle motor during read/write operations while also reducing the likelihood of the HGA and/or head crashing into the disk or other portion of the disk drive device when the disk drive device is powered down. Thus, certain example embodiments may reduce the size needed for disk drive devices because of the simplified single stopper/overmold protrusion design approach. Thus, as shown in FIG. 5, the VCM 106 has an overmold (not visible, but shown in and described with reference to FIGS. 6 and 7), including a partially visible overmold extrusion 602 for engaging with a single stopper pin (also not visible, but also shown in and described with reference to FIGS. 6 and 7).

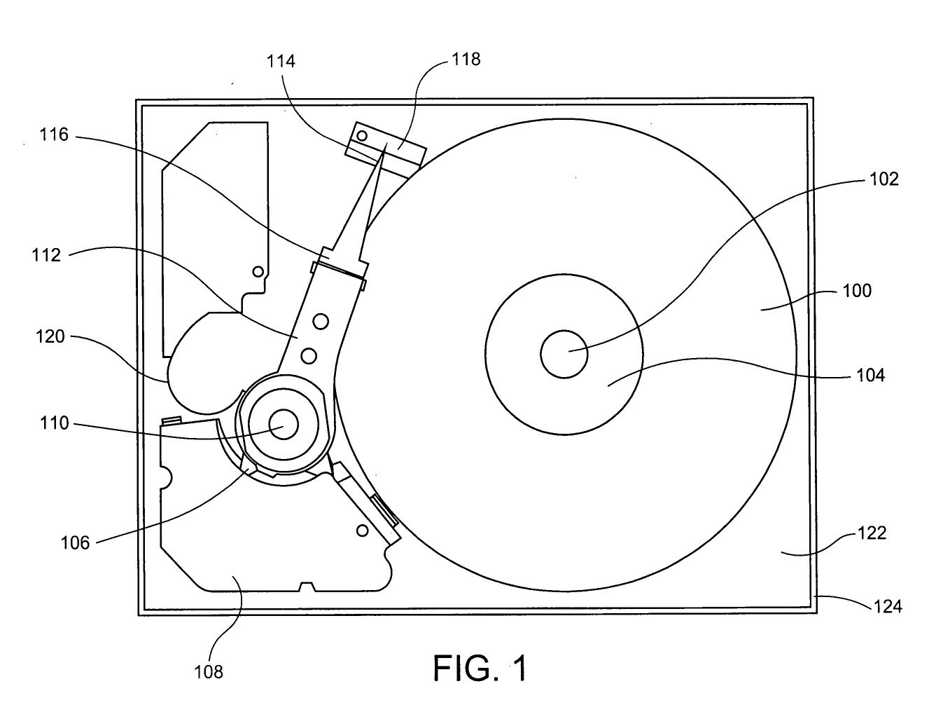

FIGS. 6 and 7 better illustrate the overmold 600 and the overmold extrusion 602 cooperating with the stopper pin 604. The overmold extrusion 602 of FIGS. 6 and 7 appears as a single protrusion; however, the present invention is not so limited. By way of example and without limitation, certain example embodiments may use other shapes for the overmold extrusion 602, including, for example, a substantially U-shaped overmold extrusion (described in greater detail below). As will be appreciated from a comparison between FIG. 5 and FIG. 1, certain example embodiments may allow for a smaller disk drive device having a simplified device.

Referring more particularly to FIG. 6, FIG. 6 is a partial schematic view of a disk drive device having a VCM overmold with an overmold extrusion for cooperating with a single stopper pin with the HGA being in a read/write mode, in accordance with an example embodiment. When a current passes through the VCM 106, the HGA 116 will be rotated to a track of the disk 100. If the HGA 116 happens to lose control, the VCM overmold 600 will contact the stopper pin 604, thereby reducing the chances of the head crashing (e.g., into the clamp 104) by setting a load position limit.

Similar to FIG. 6, FIG. 7 is a partial schematic view of a disk drive device having a VCM overmold with an overmold extrusion for cooperating with a single stopper pin with the HGA being in a parked mode, in accordance with an example embodiment. As shown in FIG. 7, when the disk drive device is shut off (or in another non-working condition), there will be no controlling signal (or an incorrect controlling signal) supplied to the VCM 106. Accordingly, the HGA 116 will return to the unloading position by means of a flex bias force, and the head will be parked on the ramp 118. This will, for example, protect the head and/or disk 100 from damage (e.g., from external forces, shocks, etc.) and allow for easy loading of the head the next time the disk drive device is to operated. The overmold extrusion 602 will contact the stopper pin 604 to set a parked position limit, thereby helping to ensure that the head is properly parked on the ramp and/or reducing the likelihood of damage to the components of the disk drive device (e.g., caused by over-rotation).

In certain other example embodiments, the overmold extrusion may be substantially U-shaped. The stopper pin 604 may be located within the cavity of the substantially U-shaped overmold extrusion such that the legs of this overmold extrusion at least partially surround the stopper pin 604. Thus, one leg of the substantially U-shaped overmold extrusion may help to set the load position limit (rather than the VCM overmold 600 itself setting the load position limit as in FIG. 6), and the other leg of the substantially U-shaped overmold extrusion may help to set the parked position limit (similar to the overmold extrusion 602 shown in FIG. 6). Rather than being substantially U-shaped, more than one (e.g., two) protrusions similarly may be disposed on the VCM to cooperate with the pin to set maximum rotation positions.

It will be appreciated that although certain example embodiments have been described as relating to a VCM overmold having an overmold extrusion associated therewith, the present invention is no so limited. By way of example and without limitation, any protrusion extending from the distal portion suitable for cooperating with a single stopper pin may be used. That is, the protrusion itself need not be extruded from the VCM molding. Furthermore, such protrusion may be formed from the same material as a VCM overmold, or it may be formed on and/or connected in some other way to a VCM overmold or to the VCM itself.

It also will be appreciated that the stopper pin 604 may be formed from any suitable material(s). For example, the stopper pin 604 may extend upward by molding, mechanical assembly, or any other suitable means. Also, the VCM overmold may be formed from any suitable material.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A voice coil motor for use in a disk drive device suitable for causing rotation of a head gimbal assembly connected to a first end of the voice coil motor, comprising:
at least one protrusion protruding from a second end of the voice coil motor, the second end of the voice coil motor being opposed to the first end,
wherein the voice coil motor is rotatable to move a head connected to the head gimbal assembly for a read and/or write operation and for parking, and
wherein the protrusion is disposed on the voice coil motor so as to cooperate with a pin to define first and second maximum positions beyond which the voice coil motor cannot rotate.

2. The voice coil motor of claim 1, further comprising an overmold formed on the voice coil motor.

3. The voice coil motor of claim 2, wherein the protrusion is formed on the overmold.

4. The voice coil motor of claim 2, wherein the protrusion is extruded from the overmold.

5. The voice coil motor of claim 1, wherein the first maximum position is a load position limit beyond which the voice coil motor cannot rotate during a read/write operation, and wherein the second maximum position is a park position limit beyond which the voice coil motor cannot rotate when the head is parked.

6. The voice coil motor of claim 1, wherein the first maximum position is defined by the protrusion contacting the pin, and wherein the second maximum position is defined by voice coil motor contacting the pin.

7. The voice coil motor of claim 1, wherein the protrusion is substantially U-shaped, the protrusion having a base and two legs extending from the base of the protrusion.

8. The voice coil motor of claim 7, wherein the legs of the substantially U-shaped protrusion define the first and second maximum positions.

9. The voice coil motor of claim 1, further comprising a first protrusion and a second protrusion, both the first protrusion and the second protrusion being disposed on the voice coil motor so as to cooperate with the pin.

10. The voice coil motor of claim 9, wherein the first protrusion defines the first maximum position and the second protrusion defines the second maximum position.

11. A disk drive device, comprising:
a disk;
a spindle motor operable to spin the disk;
a pin; and,
a voice coil motor suitable for causing rotation of a head gimbal assembly connected to a first end of the voice coil motor, the voice coil motor including at least one protrusion protruding from a second end of the voice coil motor, the second end of the voice coil motor being opposed to the first end,
wherein the voice coil motor is rotatable to move a head connected to the head gimbal assembly for a read and/or write operation and for parking, and
wherein the protrusion is disposed on the voice coil motor so as to cooperate with the pin to define first and second maximum positions beyond which the voice coil motor cannot rotate.

12. The disk drive device of claim 11, further comprising an overmold formed on the voice coil motor.

13. The disk drive device of claim 12, wherein the protrusion is formed on the overmold.

14. The disk drive device of claim 12, wherein the protrusion is extruded from the overmold.

15. The disk drive device of claim 1, wherein the first maximum position is a load position limit beyond which the voice coil motor cannot rotate during a read/write operation, and wherein the second maximum position is a park position limit beyond which the voice coil motor cannot rotate when the head is parked.

16. The disk drive device of claim 11, wherein the first maximum position is defined by the protrusion contacting the pin, and wherein the second maximum position is defined by voice coil motor contacting the pin.

17. The disk drive device of claim 11, wherein the protrusion is substantially U-shaped, the protrusion having a base and two legs extending from the base of the protrusion.

18. The disk drive device of claim 17, wherein the legs of the substantially U-shaped protrusion define the first and second maximum positions.

19. The disk drive device of claim 11, further comprising a first protrusion and a second protrusion, both the first protrusion and the second protrusion being disposed on the voice coil motor so as to cooperate with the pin.

20. The disk drive device of claim 19, wherein the first protrusion defines the first maximum position and the second protrusion defines the second maximum position.

21. A method of making a voice coil motor for use in a disk drive device suitable for causing rotation of a head gimbal assembly connected to a first end of the voice coil motor, the method comprising:
providing at least one protrusion on a second end of the voice coil motor, the second end of the voice coil motor being opposed to the first end,
wherein the protrusion is disposed on the voice coil motor so as to cooperate with a pin to define first and second maximum positions beyond which the voice coil motor cannot rotate.

22. The method of claim 21, further comprising forming an overmold on the voice coil motor.

23. The method of claim 22, further comprising connecting the protrusion to the overmold.

24. The method of claim 22, further comprising extruding the protrusion from the overmold.

25. A method of making a disk drive device, the method comprising:
providing a disk;
providing a spindle motor configured to spin the disk;
providing a pin; and,
providing the voice coil motor of claim 21.
